(19) United States
(12) Patent Application Publication
(10) Pub. No.: US 2008/0320417 A1
(43) Pub. Date: Dec. 25, 2008

(54) Mail Status Notification System

(76) Inventors: Steven Begley, New South Wales (AU); Storm McGrath, New South Wales (AU)

Correspondence Address: BROOKS KUSHMAN P.C., 1000 TOWN CENTER, TWENTY-SECOND FLOOR, SOUTHFIELD, MI, 48075, US

(21) Appl. No.: 12/094,207

(22) PCT Filed: Nov. 17, 2006
(86) PCT No.: PCT/AU2006/001735

§ 371 Date: May 19, 2008

(30) Foreign Application Priority Data
Nov. 17, 2005 (AU) 2005906380

(51) Int. Cl. G06F 3/00

(52) U.S. Cl. 715/822

(57) ABSTRACT

The present invention provides a mail status notification system including a software application, at least one item of mail, a colour-coded identification means and at least one functional feature whereby the mail status notification system provides a means of enabling a user to quickly and easily identify the status of said mail including whether it has been sent, received, read or the like.

### FIELD OF THE INVENTION

The invention relates to the area of document tracking, notification and alert systems, and in particular, to mail status notification system which provides a means of enabling a user to quickly and easily identify the status of an item of mail including whether it has been sent, received, read or the like.

While the invention may be applied to any documents where the status is likely to require tracking such and emails, invoices, letters or the like for convenience sake, it shall be described herein in terms of a mail status notification system which is adapted to be used in conjunction with email applications.

### BACKGROUND TO THE INVENTION

A common form of communicating written information and/or forwarding documents is via email. With the increase in use of email as a means of sending or forwarding information, including important documentation, the need to be able to identify whether a recipient has received and/or read an email has become of paramount importance.

As a solution to overcome this problem, some email programs have provided an option which enables a user to request that a read receipt be sent back to them to indicate when a recipient has read an email. When the recipient opens an email to read it, a prompt appears on their screen asking whether they would like to send a read receipt back to the sender, in order to let the sender know that they have received and read the email. The disadvantage with this system is that a recipient can choose not to send the read receipt, or can escape out of the program to avoid sending the read receipt to accidentally, or intentionally, let it appear that the email has not been opened and/or read.

There have also been developed notification systems which are adapted to send an alert or phone call to the sender when the message has been read. However, the disadvantage with these systems is that the alert or phone call may be missed and the sender will remain unaware of whether their email has been received and read. Accordingly, it is an object of the present invention to overcome or substantially ameliorate the disadvantages of the prior art by providing a mail status notification system which provides a means of enabling a user to quickly and easily identify the status of an item of mail including whether it has been sent, received, read or the like.

### SUMMARY OF THE INVENTION

In a first aspect, the present invention provides a mail status notification system including:

a software application;
at least one item of mail;
a colour-coded identification means; and
at least one functional feature whereby the mail status notification system provides a means of enabling a user to quickly and easily identify the status of said mail including whether it has been sent, received, read or the like.

The mail item is preferably in the form of an email and/or message.

The colour-coded identification means preferably includes at least one colour which is adapted to indicate the status of mail which has been sent by a sender. A first colour is preferably red which is adapted to indicate that the mail has been successfully sent from the sender's computer/device. A second colour is preferably yellow which is adapted to indicate that the mail has been received by a recipient's server and/or appears in the recipient's inbox, waiting to be read. A third colour is preferably green which is adapted to indicate that the mail has been opened and/or read by the recipient.

The software application is preferably provided as a plug-in application which is adapted to be used in conjunction with an email application/program. The plug-in application preferably has provided a control panel. The control panel preferably has provided at least one functional feature which enables the user to adjust the settings and/or functionality of the system.

The functional features preferably include, but are not limited to, active tracking, invisible tracking, ensure email, self-destruct email, block save and print option, and certified email.

The ensure email preferably has provided a website URL link which, when selected, will download and display the mail/message. The ensure email preferably has at least one confirmation request that must be acknowledged, and sent back to the sender, by the recipient.

The self-destruct email preferably has a website URL link which is adapted to direct the recipient to a secure website where they can view the mail. The self-destruct email preferably has a timer/counter which is adapted to count down and/or display the time remaining for viewing the mail before it expires and disappears.

The certified email preferably has a signature section. The certified email preferably has a website URL link which can be transferred to a website of a service provider in order to validate and certify the mail and/or sender.

The mail status notification system preferably further comprises a website of a service provider which allows a sender/user to view and track mail sent using the system and/or manage their system account.

In a second aspect, the present invention provides a method of providing a mail status notification system comprising the following steps:
a sender obtaining and installing a software application on at least one computer/device;
the sender selecting and setting at least one functional feature;
the sender sending at least one item of mail to at least one recipient;
a service provider tracking the or each mail item;
a sender's email log being coloured to indicate the status of the mail.

In order that the invention may be more readily understood we will describe by way of non-limiting example of a specific embodiment thereof.

### BRIEF DESCRIPTION OF THE DRAWING FIGURES

FIG. 1 shows the mail status notification system, detailing a user's account status, according to a preferred embodiment of the invention.

FIG. 2 shows a mail log of the mail notification system according to a preferred embodiment of the invention.

FIG. 3 shows a self-destruct email according to a preferred embodiment of the invention.

FIG. 4 shows a certified email according to a preferred embodiment of the invention.

FIG. 5 shows an ensure email according to a preferred embodiment of the invention.

FIG. 6 shows the account status of the mail notification system according to a preferred embodiment of the invention.

FIG. 7 shows a report page of the mail notification system according to a preferred embodiment of the invention.

FIG. 8 shows the control panel of the mail notification system according to a preferred embodiment of the invention.

### DESCRIPTION OF A PREFERRED EMBODIMENT OF THE INVENTION

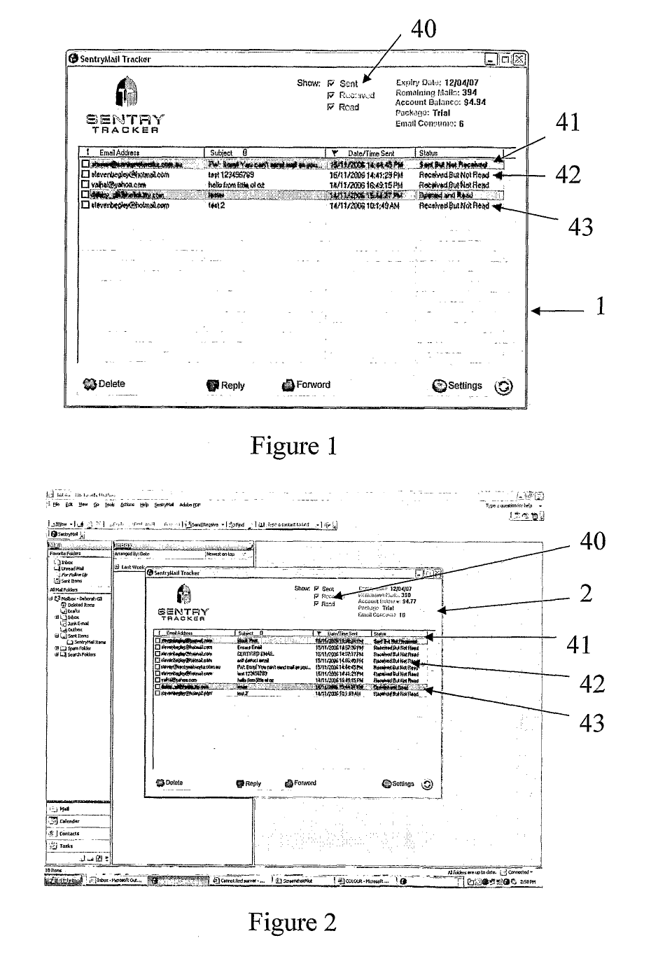

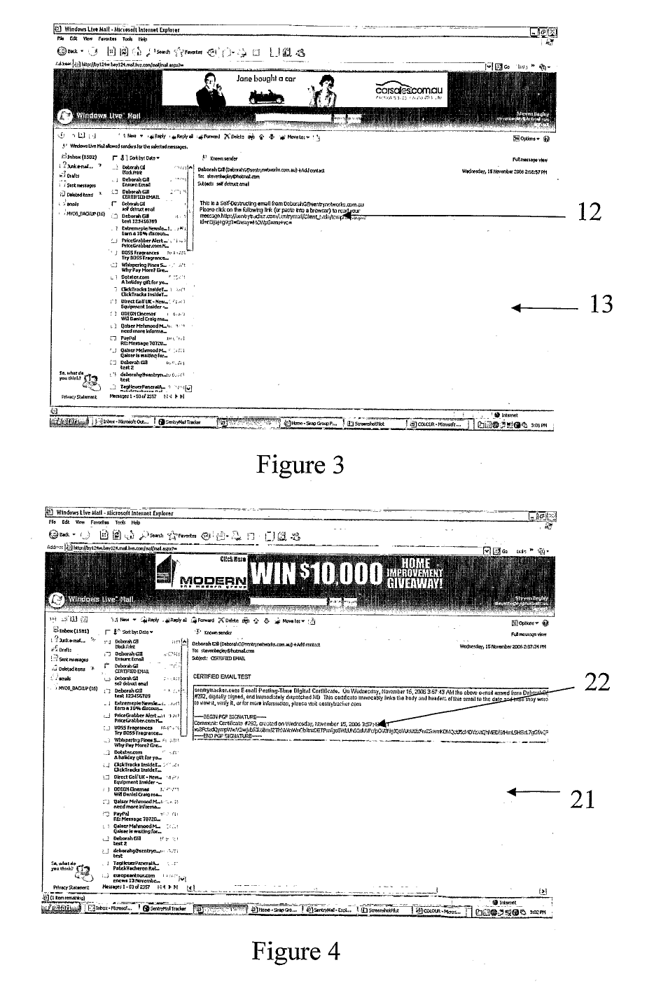

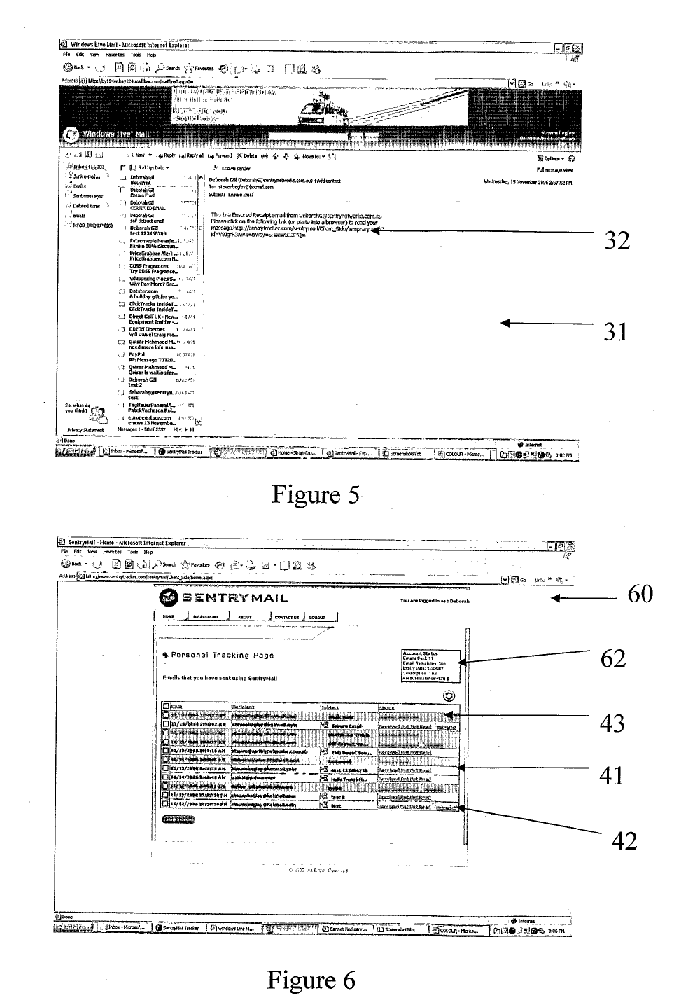

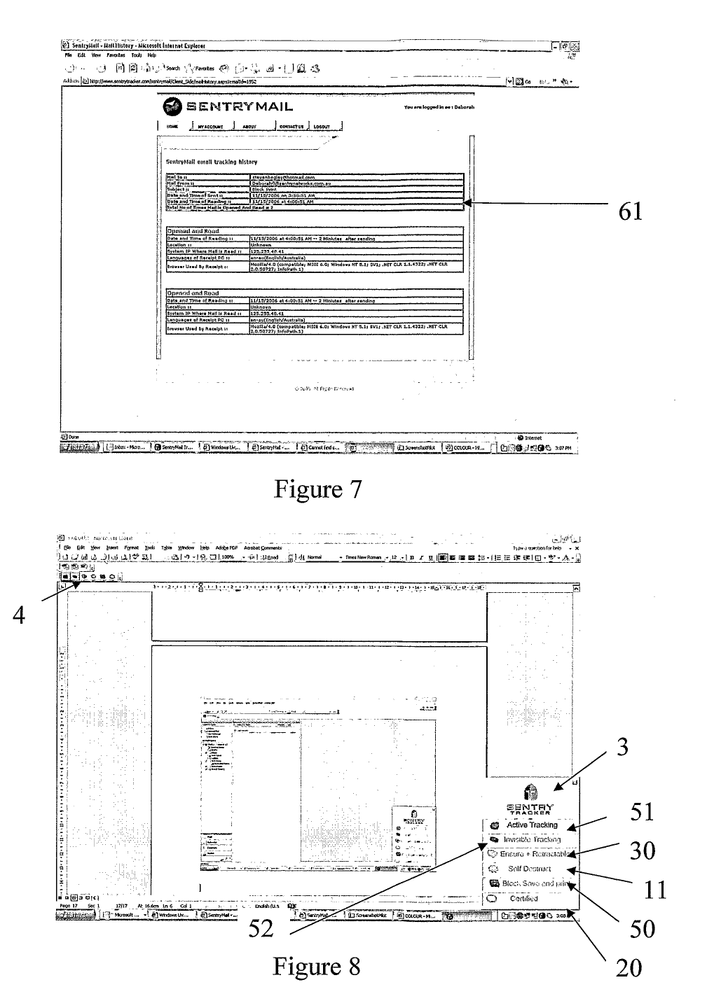

FIGS. 1 to 8 show the mail status notification system according to a preferred embodiment of the invention.

In this preferred embodiment, the invention provides a mail status notification system 1 which provides a means of enabling a user to quickly and easily identify the status of an item of mail, including whether it has been sent, received, read, deleted and/or the like. Throughout the description, the term mail is intended to refer to an email, message and/or any other suitable mail item, and will be used interchangeably with the terms email and/or message.

In a first aspect of the invention, the system 1 is provided as a software plug-in application 2 which is designed to be utilised in conjunction with non-web-based email applications. The plug-in application 2 is adapted to be installed on a computer (not shown) or server and/or any other suitable hand-held electronic device, to enable a user of the computer, server and/or networked computers to perform the various functions of the invention. It is envisaged that the software plug-in 2 may be purchased as a separate software package or alternatively, be downloadable from a suitable service provider or web server provided over an online environment such as the internet.

A software plug-in application 2 is a small software program that is adapted to work in conjunction with, and be controlled by, a browser, operating system or program to provide a user with access to additional features/functions that are otherwise not available. Accordingly, the software plug-in 2 of the invention can be provided in a number of different versions so that it will be compatible to the different browsers, operating systems and/or programs that already exist in the marketplace providing the ability for everyone to utilise the system of the invention. In a preferred format, the plug-in application 2 has a control panel that 3 can be accessed via the desktop menu and/or tool bar 5. The control panel 3 has provided at least one setting option 10 which can be selected and/or modified to enable the user to adjust the settings for the mail status notification system 1 and enable a user to tailor the functionality of the features of the system to the application as they require. It is envisaged that the system 1 of the invention may have provided default settings and options 10 which will automatically be initiated when the software plug-in 2 is installed into the computer however, these options and settings 10 may be altered at any time by a user to provide or take away features as they require.

In a preferred embodiment, the control panel 3 is provided in the form of a pop-up menu/window which can be maximised, to access and set the default settings, and minimised, when the panel is not in use. The control panel 3 is adapted to display and provide quick access to each of the setting options 10 of the system. The setting options 10 preferably include, but are not limited to, the following:
Active Tracking 51;
Invisible Tracking 52;
Ensure Email 30;
Self-Destruct/Email 11;
Block Save and Print 50; and
Certified Email 20.

Once a setting option 10 is selected prior to sending one or more mail items, that particular setting 10 will be activated and the mail will be tracked as soon as it is sent from the sender's computer. The system 1 preferably has provided at least one icon 4 which is adapted to appear on a toolbar/menu of the mail application/program a sender is using to manage their mail. Each icon 4 is adapted to correspond to a setting option 10 of the system 1 to provide quick access to that particular setting so that the sender can adjust that setting option 10 for the mail being composed.

The system 1 has provided at least one colour-coded identification means. The colour-coded identification means 40 includes at least one colour which is adapted to enable a user to quickly and easily identify the status of the mail. In a preferred embodiment, the system 1 utilises three colours, which are adapted to correspond to the colours of a traffic light, which are commonly known to most people with an implied meaning including red, yellow and green to identify the status of an item of mail. In a preferred embodiment of the invention, a first colour 41 is red, which is adapted to indicate to a sender that an email has been successfully sent from their computer to a prescribed recipient. A second colour 42 is yellow, which is adapted to indicate to a user that the mail has been received by the recipient's server and/or appears in the recipient's inbox waiting to be read. The third colour 43 is green, which is adapted to indicate to the sender that the mail has been received and/or read by a recipient. In this manner, a sender can be assured that a recipient has not only received the mail but opened/read the mail without the risk of not knowing whether the mail has been received as a result of accidental or intentional deletion of a read receipt notification provided on standard email/mail systems.

In a preferred embodiment, the colour-coded identification means 40 is provided by highlighting a mail item in a sender's mail log in the relevant colour. It is envisaged that the colour-coded identification means 40 may also be provided at the top of a mail window and/or next to the line providing details of an email item, such as sender, title, and date received, so long as the colour identification means 40 is provided in a position which is obvious to a user and readily identifiable.

In an alternate embodiment of the invention, the system 1 may have provided a second colour-coded identification means which is adapted to provide a range of colours which are adapted to indicate to a user whether documentation received is from a trusted user, known sender, or trusted payer. The second colour-coded identification means provides a means of knowing that a document is coming from a trusted source in order to decrease or eliminate spam and identification fraud and the receipt of unwanted information. It is envisaged that the user may be able to identify people on their contact list as being trusted, unsure or untrusted users such that when mail is received from them they will appear with the appropriate colour code.

In a second aspect of the invention, the system 1 is provided as a software plug-in application 2 which is designed to be utilised in conjunction with web-based mail applications in order to allow users who have free web-based mail accounts such as hotmail, yahoo, gmail etc. to take advantage of the system of the invention. The software plug-in 2 can be adapted to be connected to and/or have access to a user's pre-existing mail system to enable a user to track and record emails whilst also having the advantages of the system 1. It is envisaged that the service provider of the system 1 may incorporate a tracker or web beacon (not shown) or the like which is adapted to bypass the setting of current mail systems such that a receiver does not necessarily have to reply to a mail item in order for a user to know that their original mail item sent has been received or read. It is envisaged that the tracker or web beacon or the like may also be used to protect documents from being printed, forwarded or copied.

The self-destruct option 11 of the system is designed to assign a period of time (i.e. seconds, minutes, days) to the life of a self-destruct email 13, after which time it will expire. The sender is provided with the option of selecting a certain time limit for a specific email during composition of that email, with the settings returning to default settings once the email has been sent. The benefit of being able to send a self-destruct email/message 13 is that you can send information which you do not want stored such as passwords or other personal/security related information. This option 11 is also available for a user to send self-destruct text messages to mobiles phones and personal data assistants (PDAs).

The self-destruct email/message 13 contains a website URL link 12. When the recipient receives the email, they must click on the link 12 in order to be directed to a secure website, where they can view the email. The website/self-destruct option 11 has provided a timer/counter 14, displayed on the recipient's screen, which will count down the time available to read the actual protected email/message before it expires and disappears. Once the prescribed time has elapsed, the recipient will be unable to open the email again. At this time, the recipient is provided with the option to request that the email/message be resent. However, the sender can adjust the settings so that this possibility is blocked at the time of sending the email/message, or allow for a prescribed number of extra re-reads. Once the email has been opened by the recipient, the email/message item will be highlighted and/or marked green in the sender's email log to indicate that it has been read. The sender will be able to view further details including, but not limited to, when the receiver opened the email, how long it was accessed, what IP address what used to access the email, the country location of where the email was accessed, the number of times it has been accessed/read and whether it has been printed, saved etc.

In an alternate embodiment, the self-destruct option 11 allows a user to send an email and/or document which, if not opened by a recipient within a set period of time, will disappear from the recipient's inbox and remove the possibility of accessing the email. This feature is particularly useful for advertising campaigns where the email or promotion is only valid for a set period of time. Thus, if the recipient has not opened the email and the promotion has expired, it will simply be deleted from their inbox.

The certified email option 20 of the system allows the sender to send a certified email 21 which allows a recipient to obtain verification that the email/message 21 is legitimate and/or has been sent from a valid/known sender. The certified email 21 has provided a signature section 22 which is preferably provided at the bottom of the certified email. However, it can also be positioned in any other suitable location as desired. The signature section 22 contains a website URL link which can be transferred, via copying and pasting or any other suitable means, to a website of the service provider in order to confirm the validity of the email and/or sender. The recipient will be provided with details including, but not limited to, name of the sender, time email/message was sent, IP address of sender, country location of sender etc. It is envisaged that an Adobe Acrobat, .pdf version, of the certificate will also be available for the recipient to save or print or the like for their records.

The ensure email option 30 of the system is designed to send an ensure email 31 which enables a sender to be certain that the recipient has read the email as the recipient must acknowledge reading the email/message 31 themselves. The ensure email 31 includes a website URL link 32 which, when selected, will download and display the email/message 31 to the recipient. Once the message is displayed, the recipient will have to confirm that the email/message 31 has been opened and read. In an alternate embodiment, the system may issue the recipient with two confirmation requests, a first confirmation when the email/message 31 is opened and a second confirmation when the email/message 31 is read. Once the email has been read, the recipient is then provided with the option to save and/or print the email 31. In a preferred embodiment, if the recipient chooses to save the email/message 31 it will be saved in the recipient's email folder and no longer be stored on the server. However, this option can be changed/adjusted by the sender. The ensure email option 30 may have provided a certificate which is adapted to confirm the authenticity of the email and/or sender if it is requested by the receiver or chosen as a setting for the ensure email option by the sender. The certificate preferably shows details including, but not limited to, the time of sending, receiving and opening. The ensure email option 30 preferably also includes a digital signature, particularly for corporate users, that can be accessed upon the entering of a password or number or the like by the recipient.

The system 1 has provided a block save and print option 50 which is adapted to prevent a recipient from being able to save and/or print an email. If the recipient attempts to save and/or print the email, a warning message and/or blank/different screen will appear to indicate to a recipient that their attempt has failed and it is not possible for them to do so.

The system 1 preferably has provided a website 60. The website 60 is adapted to be provided by the service provider. The website 30 enables a sender to view and track the emails which have been sent using the system 1. Access to the website 60 and user account is preferably achieved upon registration of the product after downloaded/purchase and or during installation of the plug-in software application 2. The website also provides the sender/user with the possibility to view their account status 62 and/or manage their user account. The user is preferably able to be provided with at least one report 61 detailing their use of the system.

In practice, a user installs that software plug-in onto their system and can then select to use the defaults options or select particular options and/or settings for future mail to be sent. Alternatively, a user may choose to select the options on an individual mail basis. Once mail has been sent to a receiver it will be highlighted and/or marked red on the mail log to show it has been successfully sent from the sender's computer. The mail will then be tracked and once the mail is received by the recipient's server and/or appears in the recipient's inbox, the mail item will be highlighted and/or marked yellow on the sender's email log to show it has been received by the recipient's server and/or is sitting in the recipient's inbox waiting to be opened and read. As soon as the mail is opened to be read by the recipient, the highlighted and/or marked green on the sender's mail log to show that it has been opened and looked at by the recipient.

While the document status notification system has been described herein in terms of emails/messages it can also be applied to indicate the status of other documents such as invoices or the like. Further embodiments of the invention may also employ the use of VOIP connection, filters, warnings and payment gateways to link users to payments particularly where the system is being used in relation to accounts.

While we have described herein a particular embodiment of a mail status notification system, it is further envisaged that other embodiments of the invention could exhibit any number and combination of any one of the features previously described. However, it is to be understood that any variations and modifications can be made without departing from the spirit and scope thereof.

1. A mail status notification system including:
a software application;
at least one item of mail;
a colour-coded identification means; and
at least one functional feature whereby the mail status notification system provides a means of enabling a user to quickly and easily identify the status of said mail including whether it has been sent, received, read or the like.

2. A mail status notification system as claimed in claim 1 wherein mail is in the form of an email and/or message.

3. A mail status notification system as claimed in claim 1 wherein the software application is provided as a plug-in application which is adapted to be used in conjunction with an mail application/program.

4. A mail status notification system as claimed in claim 1 wherein the colour-coded identification means includes at least one colour which is adapted to indicate the status of mail which has been sent by a sender.

5. A mail status notification system as claimed in claim 4 wherein a first colour is adapted to indicate that the mail has been successfully sent from the sender's computer/device.

6. A mail status notification system as claimed in claim 5 wherein the first colour is red.

7. A mail status notification system as claimed in claim 4 wherein a second colour is adapted to indicate that the mail has been received by a recipient's server and/or appears in the recipient's inbox, waiting to be read.

8. A mail status notification system as claimed in claim 7 wherein the second colour is yellow.

9. A mail status notification system as claimed in claim 4 wherein a third colour is adapted to indicate that the mail has been opened and/or read by the recipient.

10. A mail status notification system as claimed in claim 9 wherein the third colour is green.

11. A mail status notification system as claimed in claim 3 wherein the plug-in application has a control panel.

12. A mail status notification system as claimed in claim 11 wherein the control panel has provided at least one functional feature which enables the user to adjust the settings and functionality of the system.

13. A mail status notification system as claimed in claim 12 wherein a first functional feature is active tracking.

14. A mail status notification system as claimed in claim 12 wherein a second functional feature is invisible tracking.

15. A mail status notification system as claimed in claim 12 wherein a third functional feature is an ensure email which enables a sender to be certain that the recipient has read the email.

16. A mail status notification system as claimed in claim 15 wherein the ensure email has provided a website URL link which, when selected, will download and display the mail/message.

17. A mail status notification system as claimed in claim 16 wherein the ensure email has at least one confirmation request that must be acknowledged, and sent back to the sender, by the recipient.

18. A mail status notification system as claimed in claim 12 wherein a fourth functional feature is a self-destruct email which is adapted to assign a period of time for the life of the mail.

19. A mail status notification system as claimed in claim 18 wherein the self-destruct email has a website URL link which is adapted to direct the recipient to a secure website where they can view the mail.

20. A mail status notification system as claimed in claim 19 wherein the self-destruct email has a timer/counter which is adapted to count down and/or display the time remaining for viewing the email before it expires and disappears.

21. A mail status notification system as claimed in claim 12 wherein a fifth functional feature is a block save and print option which is adapted to prevent a recipient from being able to save and/or print the mail.

22. A mail status notification system as claimed in as claimed in claim 12 wherein a sixth functional feature is a certified email which is adapted to enable a recipient to verify that the mail and/or sender is authentic.

23. A mail status notification system as claimed in claim 22 wherein the certified email has a signature section.

24. A mail status notification system as claimed in claim 22 wherein the certified email has a website URL link which can be transferred to a website of a service provider to validate and certify the mail and/or sender.

25. A mail status notification system as claimed in claim 1 which further comprises a website of a service provider which allows a sender/user to view and track mail sent using the system and/or manage their system account.

26. A method of providing a mail status notification system comprising the following steps:
a sender obtaining and installing software application on at least one computer/device;
the sender selecting and setting at least one functional feature;
the sender sending at least one item of mail to at least one recipient;
a service provider tracking the or each mail item;
a sender's email log being coloured to indicate the status of the mail.

27. (canceled)
